(19) United States
(12) Patent Application Publication
(10) Pub. No.: US 2007/0108189 A1
(43) Pub. Date: May 17, 2007

(54) Electric heating structure

(75) Inventors: Syh-Yuh Cheng, Zhudong Town (TW); Yu-Tsai Yang, Banqiao City (TW); Ching-Feng Chen, Zhunan Town (TW)

Correspondence Address: BRUCE H. TROXELL, 5205 LEESBURG PIKE, SUITE 1404, FALLS CHURCH, VA, 22041, US

(73) Assignee: Syntran Co., Ltd.

(21) Appl. No.: 11/340,473

(22) Filed: Jan. 27, 2006

(30) Foreign Application Priority Data
Oct. 25, 2005 (TW) 094218421

(51) Int. Cl. H05B 3/16

(52) U.S. Cl. 219/543

(57) ABSTRACT

An electric heating structure is disclosed, which comprises: a heat conducting plate for conducting thermal energy; a heating plate, disposed at the bottom of the heat conducting plate; a metal electrode, for conducting electricity; and an electric conducting element. The heating plate is further comprised of a porous insulating layer and an electric heating film made of an oxide of electric conducting ability. By enabling the metal electrode to couple to the electric heating film, and an end of the electric conducting element to couple to the metal electrode while the other end thereof is coupled to a power connecting terminal, an electrical conduction is enabled between the metal electrode, the electric conducting element, and the power connecting terminal. Hence, after electricity of the power connecting terminal is conducted from the electric conducting element to the heating plate, the electric energy is converted by the heating plate into thermal energy to be transmitted to the heat conducting plate for heating the same.

### FIELD OF THE INVENTION

The present invention relates to an electric heating structure, and more particularly, to a highly efficient electric heating structure that is substantially a device with reduced heat conducting path realized by the cooperation of an oxide conducting film with high electric heating conversion efficiency, a metallic heat conducting plate, and a porous insulating layer.

### BACKGROUND OF THE INVENTION

The technical measures taken for converting electric energy into thermal energy have been used extensively in various different electric heating products. In general, a prior art uses a nickel-chromium wire to produce a Joule Effect for converting electric energy into thermal energy. However, most of those convention electric heating products have poor electric heating conversion efficiency, which is the cause of energy loss during the converting of electric power into thermal power that is further being affected by the impedance of the material used as well as the non-Joule thermal energy conversion. Therefore, an oxide electric heating film with a comparatively higher electric heating conversion efficiency was developed by the manufacturers of the related industry, which is a layered film structure made of a semiconductor oxide material with specific resistance coefficient. In general, the electric heating film is a spiral high-resisting metal film (such as an alloy of nickel, chromium, and iron) with very low capacitance and inductance, and it shows a very good resisting property at the frequency of the public utility power, i.e. 60 Hz, so that electric energy can be converted completely into thermal energy thereby. It is noted that, under the same input power, an electric heating film has much higher electric heating conversion efficiency than the nickel-chromium wire.

The structures of the foregoing oxide electric heating film have been disclosed in US20020190051, US20040026411, WO0198054, and EP1571888, etc. Referring to US20020190051, a heating plate 82 is substantially a structure of a substrate 82a coated with an electric heating film 82b, whereas a heating coil 82c is disposed on the electric heating film 82b, and both ends of the heating coil 82c are respectively arranged with an electrode 82d. Although the area of the heating coil 82c installed on the substrate 82a can be made as large as required, the efficiency of the heating plate 82 is still restricted by the electric conductivity of the metal making the heating coil 82c and the electric power required thereby. Therefore, in order to enable the heating plate 82 to have good performance, the structure of the electric heating film 82b becomes relatively complicated. Further, there are gaps existed in the heating coil 82c, which will cause the substrate 82a to be heated unevenly.

Moreover, since the electric heating film is electrically conductive, therefore it is necessary to coat an insulating layer on the electrically conductive substrate, and such technical measures have been disclosed in the patents of US20050167414, U.S. Pat. No. 6,752,071, WO0111924, and JP2000275078. Referring to FIG. 2, which shows an electric heating film disclosed in US20050167414. In FIG. 2, both the upper and lower surfaces of the electric heating film 91 are coated with insulating layers 92, 93, while the electric heating film 91 is coupled to the bottom of substrate 94 made of metal or, electrically conductive materials. However, the foregoing structure still has the following drawbacks:

1. The difference between the coefficients of thermal expansion of the insulating layers 92, 93 and the electric heating film 91 is large, which may cause the insulating layers 92, 93 to crack easily and consequently deteriorate the coupling of the insulating layers 92, 93 to the electric heating film 91.

2. Since the electric heating film 91 adopts a spiral thick-film resistor, and is wrapped within by the insulating layers 92, 93, overheating may occur due to the uneven heat dispersion, and the electric heating film 91 may be fused.

To overcome the shortcomings of using a metal substrate or substrates made of electrically conductive material, a non-metal substance such as glass, glass ceramic, or enamel steel plate is adopted, and the technical measures of this kind of non-metal substrates have been disclosed in the patents of U.S. Pat. No. 6,225,608, WO0065877, AU8069375, EP0954201, and CN1444887, etc. However, using non-metal substrates may have other issues. In addition to a poor thermal conduction, the mechanical strength of shock resistance is also poor. Even though the enamel steel plate has a higher thermal conductivity, the glaze coated on the surface of the enamel steel plate may be cracked after it is heated for a long time, and thus causing electric leaks.

There are two methods, i.e. the soldering method and insulator coating method, usually being adopted as a means of fixing contact points of an electrode to an electric heating film, which are respectively disclosed in the patents of WO0111924 and JP2003168685, etc. Since the thickness of the electric heating film is limited, therefore the soldering method may damage the strength of the electric heating film and thus causing a deformation to the electric heating film. However, the insulator coating method may cause problems to the connecting strength and working thermal expansion, which will increase the contact resistance and damage the contact points.

### SUMMARY OF THE INVENTION

In view of the shortcomings of a prior art structure, the primary objective of the present invention is to provide a highly efficient electric heating structure that is substantially a device with reduced heat conducting path realized by the cooperation of an oxide conducting film with high electric heating conversion efficiency, a metallic heat conducting plate, and a porous insulating layer.

The secondary objective of the present invention is to provide a power-saving and time-saving electric heating structure with ability of providing heating evenly.

Another objective of the present invention is to provide an electric heating structure that comes with a wide temperature adjusting range, and thus is very suitable to be applied by cooking devices.

To achieve the foregoing objectives, the present invention provides an electric heating structure, which comprises: a heat conducting plate for conducting thermal energy; a heating plate, disposed at the bottom of the heat conducting plate; a metal electrode, for conducting electricity; and an electric conducting element; wherein, the heating plate is further comprised of a porous insulating layer and an electric heating film made of an oxide of electric conducting ability; and, by enabling the metal electrode to couple to the electric heating film and an end of the electric conducting element to couple to the metal electrode while the other end thereof is coupled to a power connecting terminal, an electrical conduction is enabled between the metal electrode, the electric conducting element, and the power connecting terminal; after electricity of the power connecting terminal is conducted from the electric conducting element to the heating plate, the electric energy is converted by the heating plate into thermal energy to be transmitted to the heat conducting plate for heating the same.

Preferably, the heat conducting plate is made of a thermal conducting metal, such as stainless steel.

Preferably, the surface of the heat conducting plate is coated with a far infrared radiating material.

Preferably, the heating plate is attached on the heat conducting plate by an interface attachment reinforcing layer coated on the porous insulating layer of the heating plate.

Preferably, the interface attachment reinforcing layer is formed by thermal spraying an aluminum oxide on the porous insulating layer, or by sandblasting and fusing a glass with high thermal expansion coefficient formed on the porous insulating layer.

Preferably, the thermal expansion coefficient of the glass is 50% higher than that of the heat conducting plate.

Preferably, the porous insulating layer is made of an insulating oxide such as aluminum oxide, zirconium oxide, zeolite, lolite, and a glass powder with softening temperature below 800° C.

Preferably, the porous insulating layer includes a plurality of holes disposed evenly in the insulating layer and occupying less than 20% the volume of the porous insulating layer.

Preferably, the diameter of the hole ranges from 0.05 micron to 10 microns.

Preferably, the electric heating film is made of an electric conducting material such as tin oxide, indium oxide, and zinc oxide.

Preferably, the electric heating film is formed of the stacking of a porous insulating layer on a glass layer.

Preferably, the glass layer is formed by heating and fusing a glass powder with softening point below 800° C.

Preferably, the metal electrode is coupled to the electric heating film by the silver paste electrode.

Preferably, the metal electrode is a metal bar with high electric conductivity, which is made of copper, iron-nickel, or titanium alloys.

Preferably, the electric conducting element is a heat-resisting electric conducting plate or a conducting wire wrapped with a heat resisting material.

Preferably, the electric heating structure is arranged in a casing whereas a resilient plate is arranged between the metal electrode and the casing, so that the resilience of the resilient plate will apply a pressure on the metal electrode to assure the electric heating film to contact with the metal electrode.

Preferably, an insulating layer is disposed between the resilient plate and the metal electrode.

Preferably, the power connecting terminal is arranged on a casing, and a heat-resisting insulating plate is disposed between the electric conducting element and the casing.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a prior art heating plate as disclosed in the patent US20020190051;

FIG. 2 is a schematic view of the prior art structure of an electric heating film wrapped by an insulating layer as disclosed in the patent US20050167414;

FIG. 3A is a cross-sectional view of the structure of a preferred embodiment of the present invention;

FIG. 3B is an enlarged view of FIG. 3A; and

FIG. 4 is a schematic diagram depicting of the heating efficiency of a heater of the present invention and other heaters.

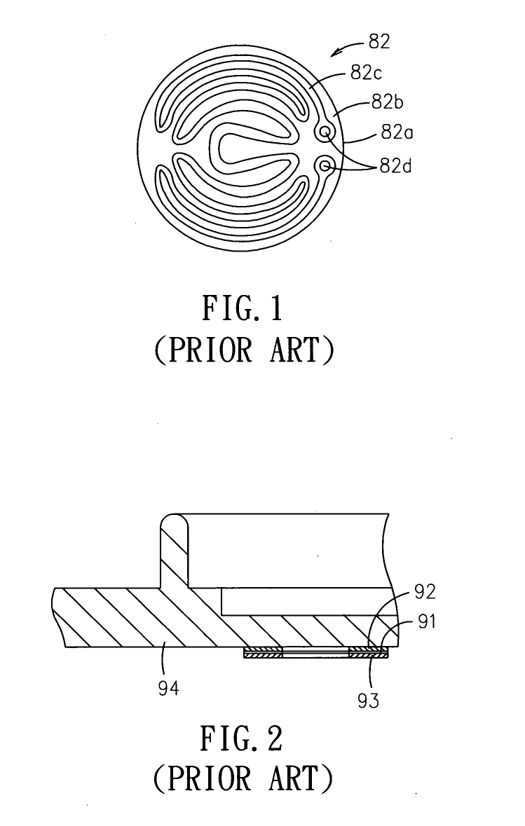

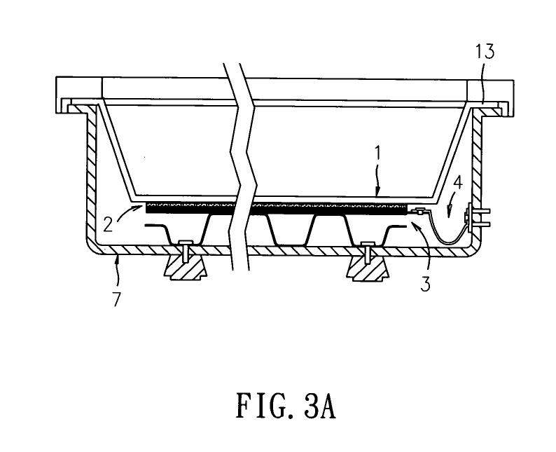

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

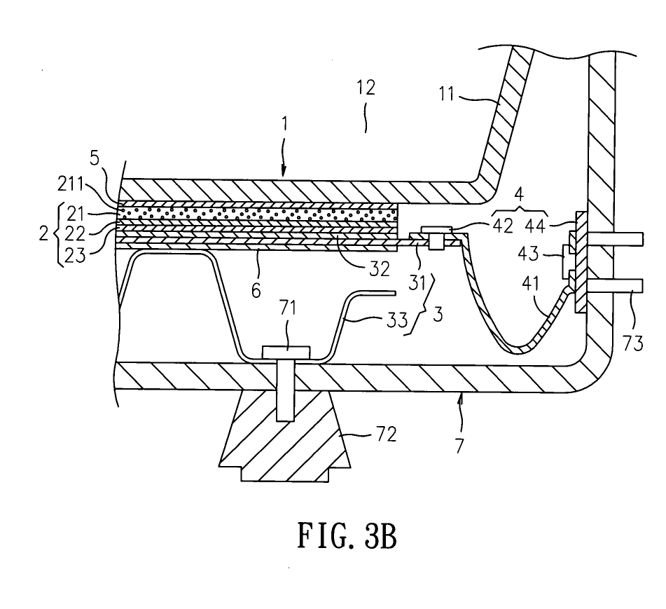

Referring to FIG. 3A for the cross-sectional view of a structure according to a preferred embodiment of the present invention and FIG. 3B for the enlarged view of the structure. In FIG. 3A and FIG. 3B, an electric heating structure of the invention is primarily comprised of a heat conducting plate 1, a heating plate 2, an electrode fixing structure 3, and a wire connecting structure 4, whereas the heat conducting plate 1, heating plate 2, electrode fixing structure 3, and wire connecting structure 4 are all arranged in a casing 7.

The heat conducting plate 1 is provided for conducting thermal energy and could be made of a heat conducting metal material such as stainless steel. As seen in FIG. 3A, a lateral side 11 of the heat conducting plate 1 is bent upward for enabling the heat conducting plate 1 to be a bowl-shape object with an internal space 12 for containing a heating object, on the other hand, the lateral side 11 can also bent downward for enabling the heat conducting plate 1 to be a platform. In addition, the surface of the heat conducting plate 1 is coated with a far infrared radiating material to enhance the thermal conducting ability of the heat conducting plate 1. Further, the the top rim 13 of the heat conducting plate 1 is embedded into the casing 7 to avoid conducting heat directly from the heat conducting plate 1 to the casing 7, and a heat insulating structure such as foam plastic, bakelite, and refractory bulk is installed at the connecting surface of the heat conducting plate 1 and the casing 7. Since the heat insulating structure is a prior art, and thus will not be described here.

The heating plate 2 is coupled to the bottom of the foregoing heat conducting plate 1 by an interface attachment reinforcing layer 5, and the interface attachment reinforcing layer 5 is a highly connectable insulating oxide layer, which could be a thermal spray aluminum oxide or a glass with high thermal expansion coefficient made by sandblasting and fusion. The coefficient of thermal expansion of the glass is 50% less than that of the heat conducting plate 1. The heating plate 2 can be further comprised of a porous insulating layer 21, a glass layer 22, and an electric heating film 23. The porous insulating layer 21 is made of an insulating oxide, such as aluminum oxide, zirconium oxide, silicon oxide, zeolite, lolite, and a glass powder with softening temperature below 800° C., and so on. Furthermore, there are holes 211 being disposed evenly in the insulating layer, whereas the holes 211 occupy less than 20% the total volume of the porous insulating layer 21 and is used for adjusting the thermal expansion coefficient of the porous insulating layer 21. It is noted that the diameter of the holes 211 ranges from 0.05 micron to 10 microns and is preferred to be between 0.2 micron to 3 microns. The electric heating film 23 is an oxide electric heating film with resistance coefficient below 10-3 Ω●cm and is made of an electric conducting material such as tin oxide, indium oxide, and zinc oxide and, which can produce Joule heat by passing a current. The glass layer 22 is formed by heating and fusing a glass powder with softening point below 800° C. and is disposed between the electric heating film 23 and the porous insulating layer 21, which is used as an adhesive for adhering the electric heating film 23 to the porous insulating layer 21. In addition, the dense structure of the glass layer 22 also facilitates the production of the electric heating film 23.

The electrode fixing structure 3 comprises a metal electrode 31, a silver paste electrode 32, and a resilient plate 33. The metal electrode 31 a metal bar with high electric conductivity, which is made of copper, iron-nickel, or titanium alloys. The silver paste electrode 32 is adhered onto the electric heating film 23, and thus the metal electrode 31 and the silver paste electrode 32 constitute the terminal electrode of the electric heating film 23. The resilient plate 33 is a metal plate made of a resilient stainless steel and is being arranged between the bottom the metal electrode 31 and the casing 7. The insulating layer 6 is disposed between the resilient plate 33 and the metal electrode 31, such that the resilience of the resilient plate 33 will apply a pressure onto the metal electrode 31 for preventing a poor contact of the metal electrode 31 caused by the stress produced when the electric heating film 23 is working. Since there is an insulating layer 6 between the metal resilient plate 33 and the metal electrode 31, therefore the resilient plate 33 can be fixed directly onto the bottom of the casing 7. As shown in FIG. 3B. The resilient plate 33 is secured to the bottom of the casting 7 by a screw 71 pre-soldered onto the casing 7.

The wire connecting structure 4 comprises an electric conducting element 41, which could be a heat-resisting electric conducting plate or a conducting wire wrapped by a heat resisting material. An end of the electric conducting element 41 is riveted to the metal electrode 31 by a rivet 42, and the other end is riveted to the power connecting terminal 73 of the casing 7 through the heat-resisting insulating plate 44 by a rivet 42, such that the metal electrode 31, the electric conducting element 41, and the power connecting terminal 73 constitute an electric connecting state. An external power supply is inputted to the electric conducting element 41 through the power connecting terminal 73, and the heat-resisting insulating plate 44 can prevent current from passing to the casing 7.

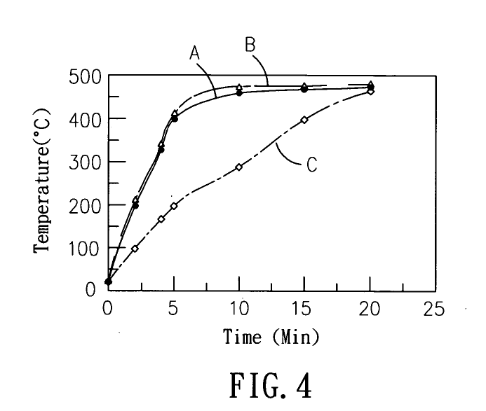

Please refer to FIG. 4, which is a schematic diagram depicting of the heating efficiency of a heater of the present invention and other heaters. In FIG. 4, the temperature rise at the center of the surface of the heat conducting plate is measured under the same condition of using an electric power of 1 kW, wherein:

Curve A: An electric heating wire (Ni—Cr) heater is soldered directly onto the heat conducting plate having the same thickness as the heat conducting plate of the electric heating film. Since the electric heating wire is enclosed in a metal pipe by an insulating powder (such as magnesium oxide or aluminum oxide), heat is transmitted to the heat conducting plate for heating through the insulating powder and the metal interface, and finally dispersed from the heat conducting plate to the entire metal surface. Therefore the speed of the temperature rise is slower than that of the electric heating film.

Curve B: The electric heating film of the present invention directly adopts the heating efficiency curve of the heat conducting plate, and fully demonstrates that Curve A has over 30% increase of the heating speed than the traditional electric heating wire (Ni—Cr) heater.

Curve C: The surface of the heat conducting plate is coated with a far infrared radiating ceramic material, and the overall temperature rise effect is similar to Curve B obtained when the far infrared material is not added. Since the ceramic surface has a lower heat dispersing effect than metal, therefore a slightly higher temperature rise is measured.

Referring to FIGS. 3A and 3B, the structure of the present invention has the following advantages:

1. The use of an electric heating film 23 made of an oxide electric conducting material with high electric heating conversion efficiency in the electric heating structure of the invention can effectively lower the capacitance and inductance when a current is passed, and thus showing the properties of a good resistor.

2. As the electric heating film 23 is coated directly onto the bottom of the heat conducting plate 1, that is, being coated directly on the porous insulating layer 21 of the heat conducting plate 1, thus, while the heat conducting plate 1 is used as a heating plate, the electric heating structure will have shorter heat transmitting path and a direct heat transmitting, comparing to those of prior art, such that heat loss can be reduced and heat transmission can be maximized to achieve higher heating efficiency. Under the condition of the same power input, the heating speed of the heating structure of the invention can be improved more than 30% over the traditional electric heating structure.

3. The electric heating film 23 is adhered onto the surface of the porous insulating layer 21, and the insulating layer 21 not only can avoid electric leaks between the electric heating film 23 and the heat conducting plate 1, but its porous property also can provide a buffer for the stress produced by the different coefficients of thermal expansion of the heat conducting plate 1 and the electric heating film 23, so as to avoid possible cracks produced by a drastic temperature change of the electric heating film 23.

4. The terminal electrode of the electric heating film 23 is coated onto the metal electrode 31 by the silver paste electrode 32, and the metal electrode 31 is coupled to the power connecting terminal 73 through the rivet 42, the electric conducting element 41, and the rivet 43, such that the electric heating film 23 can maintain a low electric status for a long time use.

5. The metal electrode 31 uses the resilient plate 33 made of a resilient metal presses the electric heating film 23 through the insulating layer 6 to assure good electric contacts between the metal electrodes 31 as well as the silver paste electrode 32 and the silver paste when the electric heating film 23 is working.

6. The electric heating film 23 is adhered directly onto the heat conducting plate 1 for assuring the overall heating efficiency of the heat conducting plate 1, so as to achieve the power-saving, time-saving, and even heating effects. Such electric heating structure is particularly suitable for cooking utensils.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An electric heating structure, comprising:
a heat conducting plate, for conducting thermal energy;
a heating plate, disposed at the bottom of the heat conducting plate, further comprising a porous insulating layer and an electric heating film made of an electric conducting oxide;
a metal electrode, coupled with the electric heating film, for conducting electricity; and
an electric conducting element, having an end coupled to the metal electrode and another end coupled to a power connecting terminal;
such that an electrical conduction is enabled between the metal electrode, the electric conducting element, and the power connecting terminal, and after electricity of the power connecting terminal is conducted from the electric conducting element to the heating plate, the electric energy is converted by the heating plate into thermal energy to be transmitted to the heat conducting plate for heating the same.

2. The electric heating structure of claim 1, wherein the heat conducting plate is made of a heat conducting stainless steel material.

3. The electric heating structure of claim 1, wherein the surface of the heat conducting plate is coated with an infrared radiating material.

4. The electric heating structure of claim 1, wherein the heating plate is attached on the heat conducting plate by an interface attachment reinforcing layer coated on the porous insulating layer of the heating plate.

5. The electric heating structure of claim 4, wherein the interface attachment reinforcing layer is formed by a means selected from the group consisting of: thermal spraying an aluminum oxide on the porous insulating layer; and sandblasting and fusing a glass with high thermal expansion coefficient formed on the porous insulating layer.

6. The electric heating structure of claim 5, wherein the thermal expansion coefficient of the glass is 50% higher than that of the heat conducting plate.

7. The electric heating structure of claim 1, wherein the porous insulating layer is made of an insulating oxide selected from the group consisting of aluminum oxide, zirconium oxide, zeolite, lolite, and a glass powder with softening temperature below 800° C.

8. The electric heating structure of claim 1, wherein the porous insulating layer includes a plurality of holes evenly distributed in the insulating layer while occupying less than 20% the volume of the porous insulating layer.

9. The electric heating structure of claim 8, wherein the hole has a diameter ranging from 0.05 micron to 10 microns.

10. The electric heating structure of claim 1, wherein the electric heating film is made of an electric conducting material selected from the group consisting of tin oxide, indium oxide, and zinc oxide.

11. The electric heating structure of claim 1, wherein the electric heating film is coupled with the porous insulating layer by a glass layer.

12. The electric heating structure of claim 11, wherein the glass layer is formed by heating and fusing a glass powder with softening point below 800° C.

13. The electric heating structure of claim 1, wherein the metal electrode is coupled to the electric heating film by a silver paste electrode.

14. The electric heating structure of claim 1, wherein the metal electrode is a highly electrical conducting metallic bar made of a material selected form the group consisting of copper, iron-nickel, and titanium alloys.

15. The electric heating structure of claim 1, wherein the electric conducting element is an element selected form the group consisting of a heat-resisting electric conducting plate and an electric conducting wire coated with a heat-resisting material.

16. The electric heating structure of claim 1, wherein the electric heating structure is arranged in a casing whereas a resilient plate is arranged between the metal electrode and the casing, for enabling the resilience of the resilient plate to apply a pressure on the metal electrode so as to assure the electric heating film to contact with the metal electrode.

17. The electric heating structure of claim 16, an insulating layer is disposed between the resilient plate and the metal electrode.

18. The electric heating structure of claim 1, wherein the power connecting terminal is arranged on a casing, and a heat-resisting insulating plate is disposed between the electric conducting element and the casing.
